(19) United States
(12) Patent Application Publication
(10) Pub. No.: US 2026/0280458 A1
(43) Pub. Date: Sep. 17, 2026

(54) STATE LIMITING AN APPLIANCE MOTOR

(71) Applicant: Haier US Appliance Solutions, Inc., Wilmington, DE (US)

(72) Inventors: Joseph Wilson Latham, Louisville, KY (US); Joshua Duane Longenecker, Louisville, KY (US)

(21) Appl. No.: 19/076,466

(22) Filed: Mar. 11, 2025

(51) Int. Cl. H02P 21/14; H02K 7/14; H02K 11/33; H02K 21/02; H02K 41/02; H02P 21/00

(52) U.S. Cl. CPC H02P 21/14; H02K 7/14; H02K 11/33; H02K 21/02; H02K 41/02; H02P 21/50

(57) ABSTRACT

A method for operating a motor of a domestic appliance is provided. The method includes obtaining a target signal for the motor. The method also includes obtaining a feedback measurement of a component of the domestic appliance. Further, the method includes in response to the feedback measurement exceeding a threshold, determining an upper limit based, at least in part, on a difference between the threshold and the feedback measurement. Furthermore, the method includes limiting the target signal by the upper limit. In addition, the method includes controlling the motor based on the limited target signal.

### FIELD OF THE INVENTION

The present subject matter relates generally to an electric motor, and more particularly, to a state limiting method for an electric motor.

### BACKGROUND OF THE INVENTION

Certain conventional air conditioning and refrigeration systems use sealed systems to move heat from one location to another. Certain sealed systems may perform either a refrigeration cycle (e.g., to perform a cooling operation in an appliance such as a refrigerator) or a heat pump cycle (e.g., to heat an indoor room) depending on the appliance and the desired direction of heat transfer. However, the operating principles of both cycles or modes of operation are identical.

Specifically, sealed systems include a plurality of heat exchangers coupled by a fluid conduit charged with refrigerant. A compressor continuously compresses and circulates the refrigerant through the heat exchangers and an expansion device to perform a vapor-compression cycle to facilitate thermal energy transfer. In most sealed systems, an electric motor directly drives the compressor to compress a refrigerant. Notably, such sealed systems often have a certain burst pressure limit per appliance safety standards or regulatory standards.

However, conventional motor controls do not include effective safeguards to avoid operations that result in one or more variables of the motor exceeding respective thresholds. Notably, conventional motor controls may be limited to power limiting methods. However, other variables may require limiting to prevent undesirably high performance of the sealed system.

Accordingly, an improved method for operating an appliance motor would be desirable. More particularly, a method of effectively limiting motor variables in an appliance to ensure performance of the sealed system remain below one or more performance thresholds would be particularly beneficial.

### BRIEF DESCRIPTION OF THE INVENTION

Aspects and advantages of the invention will be set forth in part in the following description, or may be apparent from the description, or may be learned through practice of the invention.

In one exemplary aspect of the present disclosure, a method for operating a motor of a domestic appliance is provided. The method includes obtaining a target signal for the motor. The method also includes obtaining a feedback measurement of a component of the domestic appliance. Further, the method includes, in response to the feedback measurement exceeding a threshold, determining an upper limit based, at least in part, on a difference between the threshold and the feedback measurement. Furthermore, the method includes limiting the target signal by the upper limit. In addition, the method includes controlling the motor based on the limited target signal.

In one exemplary aspect of the present disclosure, a motor assembly is provided. The motor assembly includes a motor and an inverter electrically coupled to an alternating current power supply and the motor. The motor assembly also includes a controller in operative communication with the inverter. The controller is configured to perform operations for controlling the motor. The operations include obtaining a target signal for the motor. The operations also include obtaining a feedback measurement of a domestic appliance component. Further, the operations include, in response to the feedback measurement exceeding a threshold, determining an upper limit based, at least in part, on a difference between the threshold and the feedback measurement. Furthermore, the operations include limiting the target signal by the upper limit. In addition, the operations include controlling the motor based on the limited target signal.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front elevation view of a refrigerator appliance according to one or more additional example embodiments of the present disclosure.

FIG. 2 is a schematic view of certain components of the example refrigerator appliance of FIG. 1.

FIG. 3 provides a schematic diagram of an example permanent magnet synchronous motor according to one or more additional example embodiments of the present disclosure.

FIGS. 4A-4B provide block diagrams of example implementations of a motor assembly operating in a field-oriented control (FOC) scheme according to example embodiments of the present disclosure.

FIG. 5 provide block diagrams of example implementations of a motor assembly operating in a single-phase vector-like control scheme according to example embodiments of the present disclosure.

FIG. 6 provides a flowchart illustrating an exemplary method of implementing state limiting control of a motor according to one or more embodiments of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained briefly above, methods for limiting the power output of motors include using the power monitor in the inverter micro software to monitor and limit the inverter output power. For example, the output power may be calculated in the inverter software based on the following equation, where V_{d}, V_{q} are the d-q phase voltages calculated by the current PI controllers, and I_{d}, I_{q} are the measured d-q phase current feedback (after transformation from abc):

$$P = \frac{3}{2} ( {V}_{d} {I}_{d} + {V}_{q} {I}_{q} )$$

Notably, however, a state of the motor may require limitation during operation of the motor. As used herein, a “state” is a set of variables that defines a dynamic system. As an example, one or more state variables may exceed a respective threshold during operation of the motor. Accordingly, state variables in addition to or other than power output may require limitation so as to maintain the variables within respective thresholds. Hence, in response to one or more state variables exceeding the respective threshold(s), the speed and/or current (Ia) of the motor may be manipulated to return the state variable(s) below the respective threshold(s).

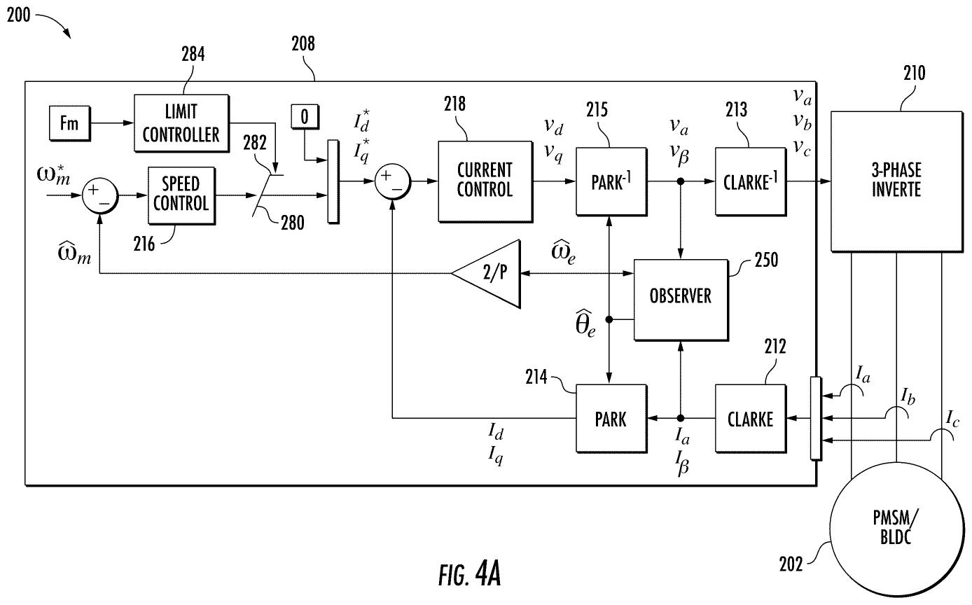

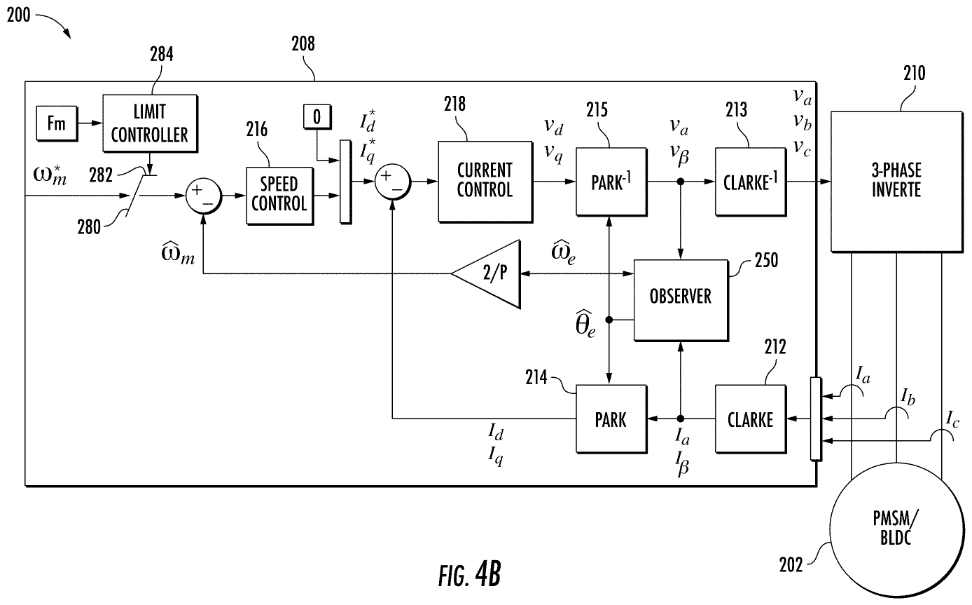

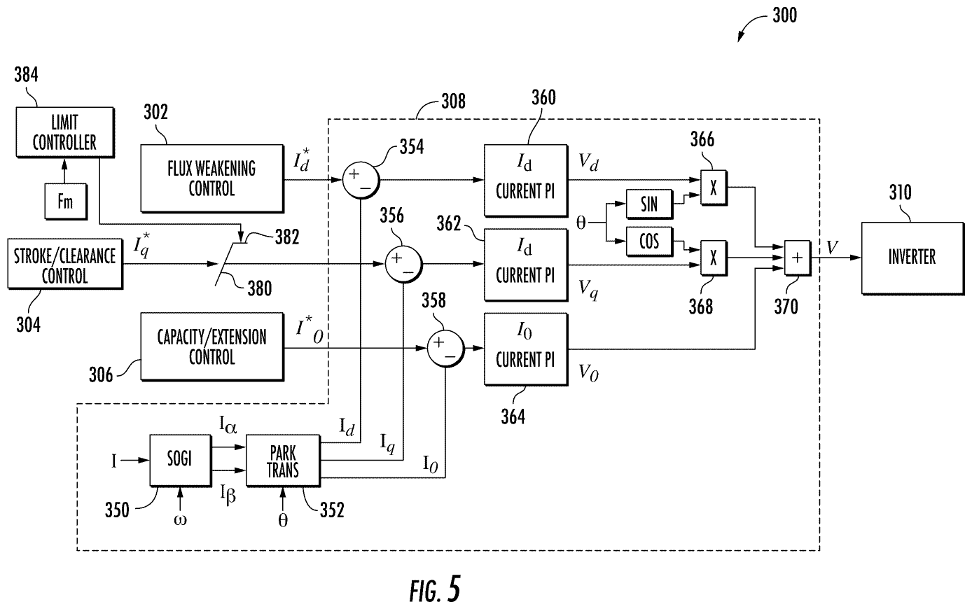

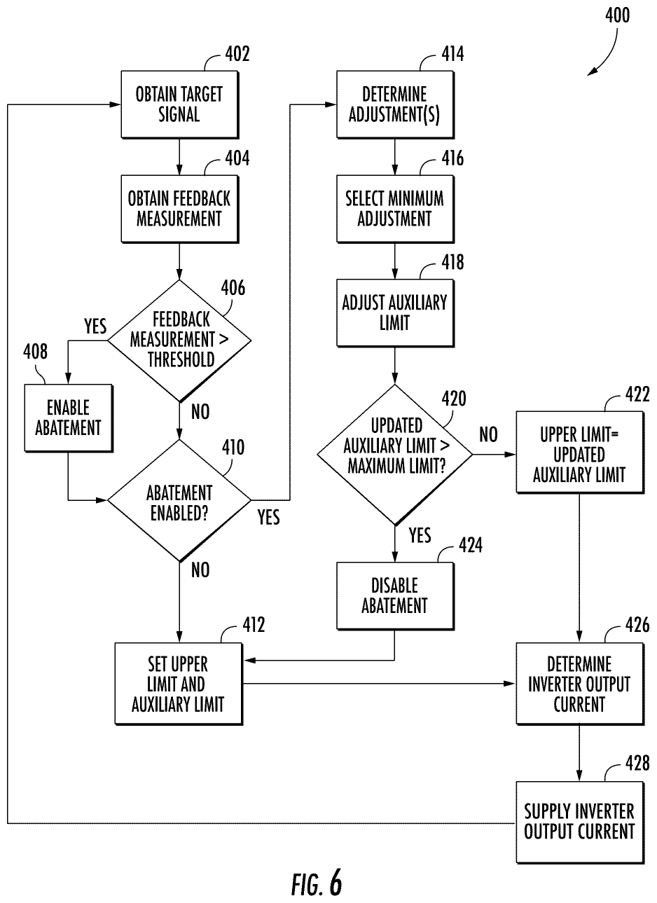

Accordingly, aspects of the present subject matter may be generally directed to state limiting methods for a motor. Specifically, as illustrated for example in FIGS. 4A-5, a limit controller may be provided that obtains feedback measurements and determines an upper limit that is applied to a target signal. As such, the target signal is limited by the upper limit. The method for imposing the upper limit will be described in further detail below with regards to FIG. 6.

The systems and methods according to example aspects of the present disclosure provide a number of technical effects and benefits. For instance, example aspects of the present disclosure provide a system and method for implementing state limiting control of a motor. This is achieved by obtaining feedback measurements of performance of the one or more components and comparing the feedback measurements to respective thresholds. In this way, when at least one feedback measurement exceeds the corresponding threshold, an abatement mode can be enabled which decrements the upper limit. Decrementing the upper limit reduces the power output of the inverter and thereby can reduce the feedback measurements. Once each feedback measurement is less than the respective threshold, the abatement mode can be configured to increment the upper limit. Incrementing the upper limit can prevent the feedback measurements from alternating between exceeding and falling below the respective thresholds. As such, the state limiting control can monitor one or more feedback measurements and adjust the upper limit to ensure performance of the sealed system remain below one or more performance thresholds.

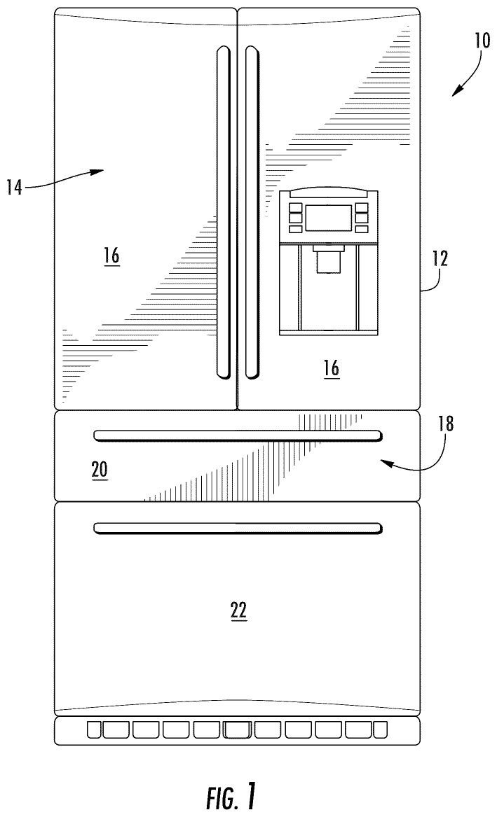

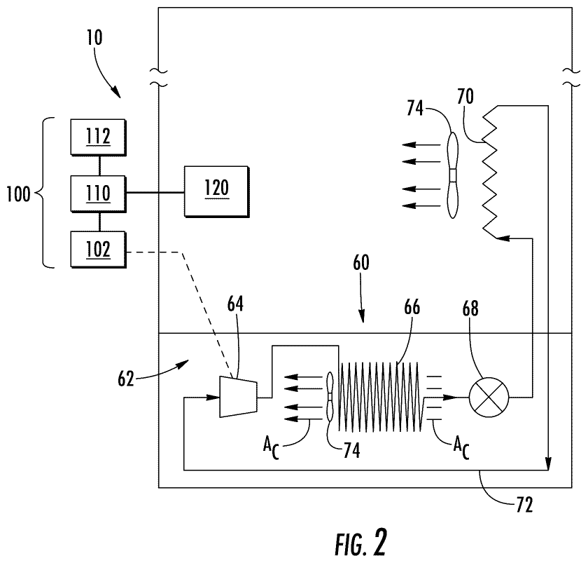

FIG. 1 depicts an exemplary domestic appliance, e.g., refrigerator appliance 10 that incorporates a sealed refrigeration system 60 (FIG. 2), according to one or more exemplary embodiments of the present disclosure. It should be appreciated that the term “refrigerator appliance” is used in a generic sense herein to encompass any manner of refrigeration appliance, such as a freezer, refrigerator/freezer combination, and any style or model of conventional refrigerator. In addition, it should be appreciated that the refrigerator appliance 10 is provided by way of example only, and aspects of the present subject matter may be used in any suitable domestic appliance having an electric motor, such as an air conditioner appliance, a dishwasher appliance, an air compressor appliance, etc.

In the illustrated example embodiment shown in FIG. 1, the refrigerator appliance 10 is depicted as an upright refrigerator having a cabinet or casing 12 that defines a number of internal chilled storage compartments. In particular, refrigerator appliance 10 includes upper fresh-food compartments 14 having doors 16 and lower freezer compartment 18 having upper drawer 20 and lower drawer 22. The drawers 20 and 22 are “pull-out” drawers in that they can be manually moved into and out of the freezer compartment 18 on suitable slide mechanisms.

FIG. 2 is a schematic view of certain components of refrigerator appliance 10, including the sealed refrigeration system 60 of refrigerator appliance 10. A machinery compartment 62 contains components for executing a known vapor compression cycle for cooling air. The components include a compressor 64, a condenser 66, an expansion device 68, and an evaporator 70 connected in series by fluid conduit 72 that is charged with a refrigerant. As will be understood by those skilled in the art, refrigeration system 60 may include additional components, e.g., at least one additional evaporator, compressor, expansion device, and/or condenser. As an example, refrigeration system 60 may include two evaporators.

Within refrigeration system 60, refrigerant flows into compressor 64, which operates to increase the pressure of the refrigerant. This compression of the refrigerant raises its temperature, which is lowered by passing the refrigerant through condenser 66. Within condenser 66, heat exchange with ambient air takes place so as to cool the refrigerant. A fan 74 is used to pull air across condenser 66, as illustrated by arrows A_{C}, so as to provide forced convection for a more rapid and efficient heat exchange between the refrigerant within condenser 66 and the ambient air. Thus, as will be understood by those skilled in the art, increasing air flow across condenser 66 can, e.g., increase the efficiency of condenser 66 by improving cooling of the refrigerant contained therein.

An expansion device 68 (e.g., a valve, capillary tube, or other restriction device) receives refrigerant from condenser 66. From expansion device 68, the refrigerant enters evaporator 70. Upon exiting expansion device 68 and entering evaporator 70, the refrigerant drops in pressure. Due to the pressure drop and/or phase change of the refrigerant, evaporator 70 is cool relative to compartments 14 and 18 of refrigerator appliance 10. As such, cooled air is produced and refrigerates compartments 14 and 18 of refrigerator appliance 10. Thus, evaporator 70 is a type of heat exchanger which transfers heat from air passing over evaporator 70 to refrigerant flowing through evaporator 70.

Collectively, the vapor compression cycle components in a refrigeration circuit, associated fans, and associated compartments are sometimes referred to as a sealed refrigeration system operable to force cold air through compartments 14, 18 (FIG. 1). The refrigeration system 60 depicted in FIG. 2 is provided by way of example only. Thus, it is within the scope of the present subject matter for other configurations of the refrigeration system to be used as well.

As described above, sealed refrigeration system 60 performs a vapor compression cycle to refrigerate compartments 14, 18 of refrigerator appliance 10. However, as is understood in the art, refrigeration system 60 is a sealed system that may be alternately operated as a refrigeration assembly (and thus perform a refrigeration cycle as described above) or a heat pump (and thus perform a heat pump cycle). Thus, for example, aspects of the present subject matter may similarly be used in a sealed system for an air conditioner unit, e.g., to perform by a refrigeration or cooling cycle and a heat pump or heating cycle. In this regard, when a sealed system is operating in a cooling mode and thus performs a refrigeration cycle, an indoor heat exchanger acts as an evaporator and an outdoor heat exchanger acts as a condenser. Alternatively, when the sealed system is operating in a heating mode and thus performs a heat pump cycle, the indoor heat exchanger acts as a condenser and the outdoor heat exchanger acts as an evaporator.

Referring still to FIG. 2, an exemplary drive assembly 100 for operating a compressor (e.g., such as compressor 64) will be described according to exemplary embodiments of the present subject matter. As illustrated, compressor 64 may be the device or machine that is used to physically compress refrigerant to facilitate operation of a sealed system (e.g., in refrigeration system 60). However, it should be appreciated that drive assembly 100 may be used in any other suitable application while remaining within the scope of the present subject matter. Moreover, any suitable type of compressor may be used, such as a reciprocating compressor, a plunger compressor, a centrifugal compressor, a screw compressor, a diaphragm compressor, an axial compressor, a rolling piston compressor, a rotary vane compressor, a scroll compressor, or any other suitable type or configuration of compressor.

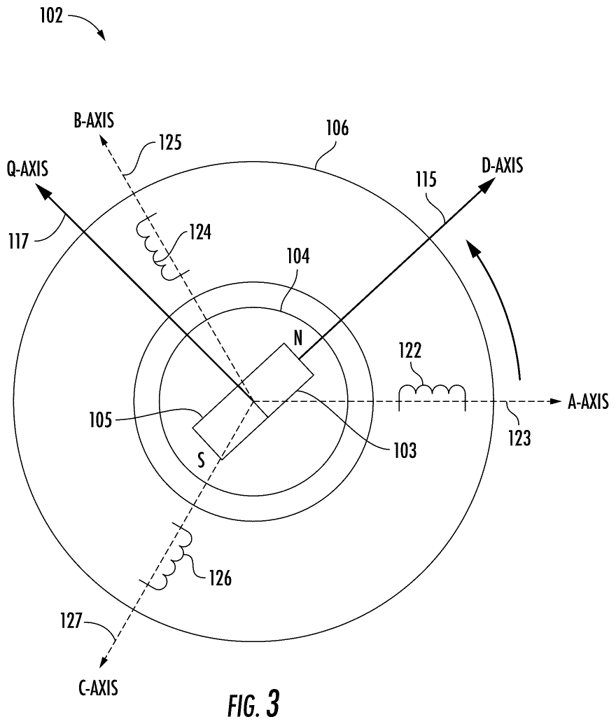

Drive assembly 100 may include a motor 102 for operating compressor 64. In this regard, motor 102 is generally configured for converting electrical energy into mechanical energy that is used to rotate, translate, or otherwise drive or operate the operating element of compressor 64. Any suitable type or configuration of motor 102 may be used. For example, as used herein, “motor” may refer to any suitable drive motor and/or transmission assembly for operating compressor 64. For example, motor 102 may include a brushless DC electric motor, a stepper motor, or any other suitable type or configuration of motor. For example, motor 102 may include an AC motor, an induction motor, a permanent magnet synchronous motor, or any other suitable type of AC motor. In addition, motor 102 may include any suitable transmission assemblies, clutch mechanisms, or other components. In some embodiments described below, motor 102 is a synchronous motor, e.g., such as a permanent magnet synchronous motor (PMSM), a brushless DC motor (BLDC), etc. operating under field-oriented control (FOC), as will be explained in more detail below (FIGS. 3-4B). In other embodiments described below, the motor 102 is a single-phase linear motor operating under a single-phase vector-like control scheme, as will be explained in more detail below (FIG. 5), that is analogous to the FOC scheme.

Drive assembly 100 may further include an inverter 110 that is operatively coupled to the motor 102 for supplying electrical energy that drives motor 102. For example, inverter 110 may be electrically coupled to a power source 112 (e.g., such as an alternating current (AC) voltage source or mains electricity). Inverter 110 is generally configured for receiving unregulated power from power source 112 and regulating it as needed to drive motor 102. For example, motor inverter 110 may control the frequency of power supplied to motor 102 to control the rotation speed of motor 102. Without inverter 110, unregulated power from power source 112 may operate motor 102 at full speed as soon as the power source 112 was turned on. As explained in more detail below, inverter 110 may regulate the operation of motor 102.

According to an exemplary embodiment, drive assembly 100 may be operably coupled to a controller 120, which is programmed to operate inverter 110, motor 102, and compressor 64 in the desired manner, as described herein. For example, controller 120 may be operably coupled to inverter 110 for regulating the output power from power source 112 as needed to drive motor 102.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of an appliance motor. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to controller 120 through any suitable network(s), such as through a high bandwidth local area network (LAN) or wide area network (WAN). In this regard, for example, controller 120 may further include a communication module or interface that may be used to communicate with one or more other component(s) of an appliance, controller 120, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As noted above, in some embodiments, the motor 102 may be a PMSM. PMSMs may be driven by field oriented control (FOC), which provides for efficient and high-fidelity control. In FOC, a stator magnetic field is generated via a stator current provided through one or more stator windings at the stator. The stator field is oriented at a fixed angular offset ahead of a rotor magnetic field at the rotor. For instance, the rotor field may be produced by one or more permanent magnets or other permanent magnetic poles at the rotor. The angular offset between the rotor field and the stator field induces rotational motion at the rotor as the rotor field is made to be aligned with the stator field. By continually moving the stator field (e.g., per phases of the stator current), the rotor is made to synchronously rotate with the stator field.

This is explained with reference to FIG. 3. FIG. 3 illustrates a schematic diagram of an example permanent magnet synchronous motor 102 according to example embodiments of the present disclosure. As illustrated, the motor 102 includes a rotor 104 and a stator 106. The rotor 104 includes a north magnetic pole 103 and a south magnetic pole 105. It should be understood that the rotor 104 is discussed with reference to a single north magnetic pole 103 and a single south magnetic pole 105 for the purposes of illustration. The rotor 104 can include any suitable (e.g., balanced) number of north and south magnetic poles 103, 105. An angle of the rotor magnetic field, represented by θₑ, is related to a mechanical angle of the rotor, represented by Om, by a number of rotor poles P. In particular, the angles are related by the equation:

$${θ}_{e} = \frac{P}{2} {θ}_{m} .$$

In addition, the (mechanical) rotor speed, represented by

$${ω}_{m} = \frac{d {θ}_{m}}{dt} ,$$

can be related to the electrical rotor speed, represented by

$${ω}_{e} = \frac{d {θ}_{e}}{dt} ,$$

by the equation:

$${ω}_{e} = \frac{P}{2} {ω}_{m} .$$

In operating the motor 102, three-phase power (e.g., current/voltage signals) can be provided at each of a plurality of stator windings 122, 124, and 126. For instance, the stator winding 122 can be positioned along an a-axis 123. The stator winding 124 can be positioned along a b-axis 125 and can receive a power signal that is 120 degrees out of phase with the signal of the stator winding 122. Additionally, the stator winding 126 can be positioned along a c-axis 127 and can receive a power signal that is −120 degrees or 240 degrees out of phase with the stator winding 122.

A convenient way to represent the behavior of the motor 102 is to treat the three-phase voltages and currents as rotating space vectors. The rotating space vectors can be broken up into cartesian components. A first component, termed the direct component or D component, can be in phase with the rotor magnetic field. This component is directed along a d-axis 115. A second component, termed the quadrature component or Q component, can be out of phase with the direct component, such as 90 degrees out of phase with the direct component. For instance, this component can be directed along a q-axis 117.

In particular, voltages and currents in the rotating-space dq reference frame can be translated from the three-phase abc reference frame by suitable transforms. For instance, one example set of transforms, the Park Transform and Clarke Transform, can be performed in cascade to convert between rotating-space and three-phase. In particular, an example Park Transform is given by:

$$[ \begin{matrix}d \\ q\end{matrix} ] = [ \begin{matrix}cos {θ}_{e} & sin {θ}_{e} \\ - sin {θ}_{e} & cos {θ}_{e}\end{matrix} ] [ \begin{matrix}α \\ β\end{matrix} ]$$

and an example Clarke Transform is given by:

$$[ \begin{matrix}α \\ β\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}}\end{matrix} ] [ \begin{matrix}a \\ b \\ c\end{matrix} ]$$

Note that alternate versions of the above transformations exist, accounting for variations in the location of a zero reference angle, whether the transformation preserves amplitude or power, etc.

In the dq frame, the electrical dynamics of the stator windings can be given by:

$$[ \begin{matrix}{v}_{d} \\ {v}_{q}\end{matrix} ] = [ \begin{matrix}{R}_{s} & - {ω}_{e} {L}_{q} \\ {ω}_{e} {L}_{d} & {R}_{s}\end{matrix} ] [ \begin{matrix}{I}_{d} \\ {I}_{q}\end{matrix} ] + [ \begin{matrix}0 \\ {λ}_{m} {ω}_{e}\end{matrix} ]$$

where Rₛ is the resistance of the stator windings; L_{d}, L_{q} are the d and q axis inductances of the stator windings, which may differ from each other based on the rotor construction; and λₘ is the magnitude of the rotor magnetic flux linkage, which can be constant for a sinusoidal motor. The voltage term λₘωₑ is known as the back electromotive force (EMF) (or counter-electromotive force), and, as can be seen in the above equation, has magnitude proportional to the rotor electrical speed de.

The motor 102 can be operated according to an operation cycle. Generally, the operation cycle can represent an operation plan of the motor over at least a period of time (and/or indefinitely). As one example, the operation cycle can define a plurality of target speeds, such as a sequence of target speeds, at which the motor is to be operated. The operation cycle may be implemented by speed control (e.g., matching actual speed of the motor to target speed) and/or by other suitable implementations, such as providing voltage and/or current signals relative to target voltage and/or current signals based at least in part on the operation cycle. The operation cycle can be software-based (e.g., stored in a memory of a controller of the motor) and/or hardware-based.

For instance, FIGS. 4A-4B illustrate block diagrams of exemplary implementations of a motor assembly 200 operating in the FOC scheme in accordance with one or more exemplary embodiments of the present disclosure. As will be discussed in greater detail below, the FOC scheme can be configured to convert a three-phase signal (e.g., current/voltage) associated with the motor drive (e.g., three-phase inverter 210) into a two-phase signal. The motor assembly 200 can include a motor 202, such as a permanent magnet synchronous motor (PMSM). The motor 202 can be driven by a reversible three-phase motor drive, which can include the three-phase inverter 210 and a power supply (e.g., an alternating current power supply) (not shown). Furthermore, the three-phase inverter 210 can be electrically coupled to the power supply. The motor drive (e.g., inverter 210 and the power supply) can be operably coupled to a controller 208. The inverter 210 can likewise be operably coupled to the power supply and configured to control motor 202. For instance, inverter 210 can supply current signals to windings at motor 202 such that the motor 202 produces rotational motion. As one example, the inverter 210 can supply three-phase current signals Iₐ, I_{b}, and I_{c} to stator windings at the motor 202 in synchronous timing such that a (e.g., permanent magnet) rotor at motor 202 rotates. The inverter 210 can produce the current signals in response to a control signal from the controller 208 (e.g., current controller 218). The controller 208 can be configured to control the inverter 210 and provide a current to one or more stators of the motor 202 to induce a stator magnetic field. In this way, the controller 208 can control an orientation of the stator magnetic field.

In some embodiments, the motor assembly 200 can include a sensorless feedback system configured to obtain feedback measurements of one or more electrical characteristics from the motor 202. For instance, the motor assembly 200 can include an observer 250 configured to implement an observer algorithm. In some embodiments, the observer 250 can be a back-EMF observer configured to process one or more feedback measurements of one or more electrical characteristics of the motor and to provide data indicative of a position or a speed of the motor 202. As used herein, a “sensorless” feedback system is operable to determine data indicative of a position and/or a speed of the motor without a position sensor or a speed sensor.

In other embodiments, the motor assembly 200 can include a sensored feedback system (not shown) configured to obtain the one or more feedback measurements. For instance, in some embodiments, the motor assembly 200 can include a sensor (e.g., encoder, Hall effect sensor, etc.) configured to obtain a velocity signal and a phase-locked loop (PLL) configured to extract the frequency and phase from the velocity signal.

The observer 250 may implement the observer algorithm in a different reference frame than the three-phase reference frame of motor 202 and/or inverter 210. For instance, the current signals from the inverter 210 can be transformed by Clarke transform 212 and/or Park transform 214 into a rotating reference frame (e.g., an estimated rotating reference frame). For instance, the current signals can be transformed into an alpha-beta reference frame by the Clarke transform 212, and the signals from Clarke transform 212 can be used by the observer 250 to produce an estimated angle. The estimated angle can be used in Park transform 214 to produce signals in an estimated rotating reference frame.

The observer 250 can additionally produce an estimated speed. The estimated speed can be compared to a target speed to determine a speed difference (e.g., a speed error). The speed difference can be provided to a speed controller 216 to determine a target current signal. The target current signal can be produced in the rotating reference frame. As such, the target current signal can include a q-axis target current component signal

$$( {I}_{q}^{*} )$$

and a d-axis target current component signal

$$( {I}_{d}^{*} ) .$$

In some embodiments, the speed controller 216 can determine the q-axis target current component signal

$$( {I}_{q}^{*} ) .$$

In some embodiments, the d-axis target current component signal

$$( {I}_{d}^{*} )$$

can be set to zero, as shown. In other embodiments, the d-axis target current component signal

$$( {I}_{d}^{*} )$$

can be determined by a flux weakening controller (not shown). The target current component signals

$$( {I}_{q}^{*} ) , ( {I}_{d}^{*} )$$

can be compared to the measured current component signals (I_{q}), (I_{d}) (e.g., from Park transform 214) to determine current component error signals (e.g., current component difference signals). More specifically, the q-axis target current component signal

$$( {I}_{q}^{*} )$$

can be compared to a q-axis measured current component signal to determine a q-axis current error signal (e_{iq}), and the d-axis target current component signal

$$( {I}_{d}^{*} )$$

can be compared to a d-axis measured current component signal to determine a d-axis current error signal (e_{id}). The q-axis and d-axis current error signals (e_{iq}), (e_{id}) can be used by a current controller 218 to produce a control signal for the inverter 210. For instance, the control signal can be a voltage signal. The voltage signal may be in the rotating reference frame. As such, the voltage signal can include a q-axis voltage component signal (v_{q}) and a d-axis voltage component signal (v_{d}). The voltage component signals (v_{q}), (v_{d}) can be transformed (e.g., by inverse Park transform 215 and inverse Clarke transform 213) to the three-phase reference frame to be used by inverter 210.

In addition, a target signal can be provided to a saturator 280 configured to limit the target signal based on an upper limit 282. A limit controller 284 can be configured to determine the upper limit 282 of the saturator 280. The limit controller 284 can be configured to determine the upper limit 282 based, at least in part, on one or more feedback measurements (Fₘ) of one or more components of the refrigerator appliance 10, as will be described in more detail below with regards to FIG. 6.

In some embodiments, as shown in FIG. 4A, the target signal can be the q-axis target current component signal

$$( {I}_{q}^{*} ) .$$

In such embodiments, the q-axis target current component signal

$$( {I}_{q}^{*} )$$

may be provided to the saturator 280 by the speed controller 216. In other embodiments, as shown in FIG. 4B, the target signal may be a target speed of the motor 202. In such embodiments, the target speed may be provided to the saturator 280. In this case, the limited target speed can then be compared to the estimated speed to determine the speed difference, as mentioned above.

As noted above, in other embodiments, the motor can be a single-phase linear motor. The single-phase linear motor can have a stator and a rotor. The rotor can be operatively coupled to a piston (e.g., a reciprocating piston) that compresses gas when operated. In some embodiments, the piston can be fitted with springs in order to allow resonant oscillation to facilitate the compression by the piston.

This is explained with reference to FIG. 5. FIG. 5 illustrate block diagrams of exemplary implementations of a motor assembly 300 operating in a single-phase vector-like control scheme in accordance with one or more exemplary embodiments of the present disclosure. As shown in the embodiment illustrated in FIG. 5, a controller can be operably coupled to the motor and can be configured to operate a motor in order to drive a rotor of the motor. More particularly, the motor assembly 300 can include a stroke controller 304 (e.g., clearance controller 304), and a capacity controller 306 (e.g., extension controller 306). As discussed in more detail below, the d-axis target current component of the motor can be specified, the stroke controller 304 (e.g., clearance controller 304) can be configured to control a q-axis current component of the motor, and the capacity controller 306 (e.g., extension controller 306) can be configured to control a target DC current component of the motor.

Furthermore, as will be discussed in more detail below with reference to FIG. 5, the motor assembly 300 can further include a single-phase vector-like controller 308. The single-phase vector-like controller 308 can be operatively coupled to the stroke controller 304 and the capacity controller 306. The motor assembly 300 can further include an inverter 310 configured to supply a variable frequency waveform to the motor. Furthermore, as will be discussed in greater detail below, the single-phase vector-like controller 308 can be configured to determine the requisite voltage needed by the inverter 310 in order to drive the motor based, at least in part, on the d-axis current component, the q-axis current component, and the DC current component.

A total magnetic flux (λ) produced by the motor includes a rotor component (λᵣ) and a stator component (λₛ). When the rotor is centered in the stator (i.e., x=0), total rotor flux (λᵣ) linked to the stator is zero. When the rotor moves forward and/or backward from the center of the stator, the rotor flux (λᵣ) increases and decreases, respectively, in a linear manner. Moreover, windings of the stator produce a stator flux proportional to a winding current in the stator winding (I) by the inductance (L). More particularly, the total flux (λ) is given by:

$${λ}_{r} \approx α x$$

$${λ}_{s} = L I$$

$$λ = {λ}_{s} + {λ}_{r} = LI + α x$$

When the total flux (λ) changes, an electromotive force voltage (EMF) is produced in the motor. More particularly, the EMF (ε) is given by:

$$ε = \dot{λ} = L \dot{I} + a \dot{x}$$

where \dot{λ} is a time derivative of the total flux, İ is a time derivative of the stator winding current, \dot{x} is a time derivative of the rotor position, and a is a motor constant. Furthermore, a\dot{x} represents a back-EMF voltage (back-EMF) of the motor.

Taking into account the above-mentioned equation for the total EMF, a total voltage (V) for the motor is given by:

$$V = RI + L \dot{I} + a \dot{x}$$

where R is a resistance of the stator windings.

As noted above, in some embodiments, the piston can be fitted with springs to allow the resonant oscillation to facilitate the compression by the piston. More particularly, the piston oscillates in an approximately sinusoidal manner. The sinusoidal oscillation of the piston is given by:

$$x ( t ) = {x}_{1} sin θ + {x}_{0}$$

where θ represents a phase of the sine wave, x₁ represents an amplitude of the sine wave, and x₀ represents an offset of a midpoint of oscillation with respect to the center of the stator winding. Those of ordinary skill in the art will understand that the asymmetric force of gas compression can induce a positive offset in the position of the sine waveform.

Taking the above-equation, the time derivative of the rotor position (for use in the total motor voltage equation) can be derived. More particularly, the time derivative of the rotor position is given by:

$$\dot{x} ( t ) = ω {x}_{1} cos θ$$

where ω=\dot{θ}. As used herein, “velocity equation” refers to the above-described equation.

Referring still the FIG. 5, the motor assembly 300 can be configured to control the amplitude of the motor current (I) and the relative phase between the motor current (I) and the back-EMF. Those of ordinary skill in the art will understand that current which is in-phase with the back-EMF generates a net force which increases stroke and capacity of the linear compressor. Likewise, those of ordinary skill in the art will understand that current which is out-of-phase with the back-EMF does not generate a net force but does affect the total voltage (V) needed by the inverter (e.g., inverter 310) to drive the motor. In this way, the out-of-phase current can be useful for flux weakening operations.

The phase of the rotor flux (θ) can be used to define an in-phase component and an out-of-phase component of the sinusoidal motor current (I). The total motor current (I) and its time derivative (İ) are given by:

$$I ( t ) = {I}_{d} sin θ + {I}_{q} cos θ + {I}_{0}$$

$$\dot{I} ( t ) = {\dot{I}}_{d} sin θ + ω {I}_{d} cos θ + {\dot{I}}_{q} cos θ - ω {I}_{q} sin θ + {\dot{I}}_{0}$$

where I_{d} is the amplitude of the current component that is out-of-phase with the back-EMF (i.e., in-phase with the rotor flux), I_{q} is the amplitude of the current component that is in-phase with the back-EMF (i.e., out-of-phase with the rotor flux), and I₀ is the amplitude of the DC current.

Thus, substituting I(t), İ(t), and \dot{x}(t) into the total voltage (V) for the motor can be represented:

$$V = ( {RI}_{d} + L {\dot{I}}_{d} - L ω {I}_{q} ) sin θ + ( {RI}_{q} + L {\dot{I}}_{q} + L ω {I}_{d} + α ω {x}_{1} ) cos θ + {RI}_{0} + L {\dot{I}}_{0}$$

$$V = {V}_{d} sin θ + {V}_{q} cos θ + {V}_{0}$$

where V_{d} is the amplitude of the voltage component that is out-of-phase with the back-EMF (i.e., in-phase with the rotor flux), V_{q} is the amplitude of the voltage component that is in-phase with the back-EMF (i.e., out-of-phase with the rotor flux), and V₀ is the amplitude of the DC voltage.

As such, in the dq frame, the electrical dynamics of the stator windings can be given by:

$$[ \begin{matrix}{V}_{d} \\ {V}_{q} \\ {V}_{0}\end{matrix} ] = [ \begin{matrix}( sL + R ) & - L ω & 0 \\ L ω & ( sL + R ) & 0 \\ 0 & 0 & ( sL + R )\end{matrix} ] [ \begin{matrix}{I}_{d} \\ {I}_{q} \\ {I}_{0}\end{matrix} ] + [ \begin{matrix}0 \\ α ω {x}_{1} \\ 0\end{matrix} ]$$

where s is a Laplace variable. Those of ordinary skill in the art will understand that the above-described equations directly parallel the dq voltage equations for a three-phase permanent magnet synchronous motor (PMSM). In this way, the motor can be controlled via a single-phase vector-like control scheme that is analogous to a FOC scheme commonly used in three-phase motors such as, e.g., PMSMs and brushless DC (BLDC) motors.

In some embodiments, the d-axis current component of the motor current can be specified. More particularly, a d-axis target current component signal

$$( {I}_{d}^{*} )$$

can be set to zero (0), as shown. In other embodiments, the motor assembly 300 may include a flux weakening controller (not shown) configured to control the d-axis current component of the motor current. In such embodiments, the flux weakening controller may be configured to determine the target d-axis current component

$$( {I}_{d}^{*} ) .$$

For instance, the flux weakening controller can be configured to adjust the target d-axis current component

$$( {I}_{d}^{*} )$$

based, at least in part, un one or more feedback measurements (e.g., current feedback, voltage feedback, etc.) of one or more electrical characteristics (e.g., current, voltage, magnetic flux, etc.) of the motor.

As mentioned above, the stroke controller 304 (e.g., clearance controller 304) may be configured to control the q-axis current component of the motor current. More particularly, the stroke controller 304 can be configured to determine a target q-axis current component

$$( {I}_{q}^{*} ) .$$

For instance, the stroke controller 304 can be configured to adjust the target q-axis current component

$$( {I}_{q}^{*} )$$

based, at least in part, on the one or more feedback measurements (e.g., current feedback).

As mentioned above, the capacity controller 306 (e.g., extension controller 306) may be configured to control the DC current component of the motor current. More particularly, the capacity controller 306 can be configured to control a target DC current component

$$( {I}_{0}^{*} ) .$$

For instance, the capacity controller 306 can be configured to adjust the target DC current component

$$( {I}_{0}^{*} )$$

based, at least in part, on the one or more feedback measurements (e.g., current feedback).

The target d-axis current component

$$( {I}_{d}^{*} ) ,$$

target q-axis current component

$$( {I}_{q}^{*} ) ,$$

and target DC current component

$$( {I}_{0}^{*} )$$

can then be passed to the single-phase vector-like controller 308. As noted above, the single-phase vector-like controller 308 can be configured to determine the requisite voltage (V) required by the inverter 310 in order to drive the motor based, at least in part, on the target d-axis current component

$$( {I}_{d}^{*} ) ,$$

the target q-axis current component

$$( {I}_{q}^{*} ) ,$$

and the target DC current component

$$( {I}_{0}^{*} ) .$$

Referring to FIG. 5, in embodiments, the single-phase vector-like controller 308 can be configured to implement single-phase DQ0 control. In such embodiments, the single-phase vector-like controller 308 can be configured to determine an actual d-axis current component (I_{d}), an actual q-axis current component (I_{q}), and an actual DC current component (I₀) based, at least in part, on current feedback measurements (I). The single-phase vector-like controller 308 can then use the actual d-axis current component (I_{d}), the actual q-axis current component (I_{q}), and the actual DC current component (I₀) to determine the total voltage (V) for the motor.

The single-phase vector-like controller 308 can be configured to set the target d-axis current component

$$( {I}_{d}^{*} )$$

to zero (0). Further, the single-phase vector-like controller 308 can be configured to adjust the target q-axis current component

$$( {I}_{q}^{*} )$$

based, at least in part, on the one or more feedback measurements. Furthermore, the single-phase vector-like controller 308 can be configured to adjust the target DC current component

$$( {I}_{0}^{*} ) .$$

The single-phase vector-like controller 308 can be configured to obtain current feedback measurements (I) and rotor flux feedback measurements. For example, the single-phase vector-like controller 308 can include a second-order generalized integrator 350 (SOGI 350) and a Park transform 352 which, when used in tandem, can be configured to determine the actual d-axis current component (I_{d}), the actual q-axis current component (I_{q}), and the actual DC current component (I₀) of the current feedback measurements (I). In order to determine the actual d-axis current component (I_{d}), the actual q-axis current component (I_{q}), and the actual DC current component (I₀) of the current feedback measurements, the SOGI 350 uses the frequency component (ω) of the rotor flux feedback measurements, and the Park Transform 352 uses the phase component (θ) of the rotor flux feedback measurements.

The single-phase vector-like controller 308 can be configured to determine a d-axis current error signal (e_{id}) between the target d-axis current component

$$( {I}_{d}^{*} )$$

and the actual d-axis current component (I_{d}) of the current feedback measurements (I). For instance, referring still to FIG. 5, the single-phase vector-like controller 308 can be configured to determine the current error signal (e_{id}) (e.g., via a comparator 354) between the target d-axis current

$$( {I}_{d}^{*} )$$

and the actual u-axis current component (I_{d}) of the current feedback measurements (I).

The single-phase vector-like controller 308 can be configured to determine a q-axis current error signal (e_{iq}) between the target q-axis current

$$( {I}_{q}^{*} )$$

and the actual q-axis current component (I_{q}) of the current feedback measurements (I). For instance, the single-phase vector-like controller 308 can be configured to provide the target q-axis current component

$$( {I}_{q}^{*} )$$

to a saturator 380 configured to limit the q-axis current setpoint

$$( {I}_{q}^{*} )$$

based on an upper limit 382. Further, a limit controller 384 may be configured to determine the upper limit 382 based on the feedback measurements (Fₘ) of the one or more components of the refrigerator appliance 10, as will be described in more detail below with regards to FIG. 6. In addition, the single-phase vector-like controller 308 can be configured to then determine the q-axis current error signal (e_{iq}) (e.g., via a comparator 356) between the constrained target q-axis current component

$$( {I}_{q}^{*} )$$

and the actual q-axis current component (I_{q}) of the current feedback measurements (I).

The single-phase vector-like controller 308 can be configured to determine a DC current error signal (eᵢ₀) between the target DC current

$$( {I}_{0}^{*} )$$

and the actual DC current component (I₀) of the current feedback measurements (I). For instance, the single-phase vector-like controller 308 can be configured to determine the DC current error signal (eᵢ₀) (e.g., via a comparator 358) between the DC current setpoint

$$( {I}_{0}^{*} )$$

and the actual DC current component (I₀) of the current feedback measurements (I).

The single-phase vector-like controller 308 can be configured to adjust the DC voltage component (V₀) based, at least in part, on the DC current error signal (eᵢ₀). For instance, the single-phase vector-like controller 308 can include a capacity current proportional-integral controller (PI) 364 (e.g., I₀ Current PI 364). The capacity current PI 364 can be configured to determine the DC voltage component (V₀) based, at least in part, on the DC current error signal (eᵢ₀). Those of ordinary skill in the art will understand that the DC voltage component (V₀) can be adjusted in any suitable manner without deviating from the scope of the present disclosure.

The single-phase vector-like controller 308 can then be configured to adjust the q-axis voltage component (V_{q}) based, at least in part, on the q-axis current error signal (e_{iq}). For instance, the single-phase vector-like controller 308 can include a stroke current PI 362 (e.g., I_{q} Current PI 362). The stroke current PI 362 can be configured to determine the q-axis voltage component (V_{q}) based, at least in part, on the q-axis current error signal (e_{iq}). Those of ordinary skill in the art will understand that the q-axis voltage component (V_{q}) can be adjusted in any suitable manner without deviating from the scope of the present disclosure.

The single-phase vector-like controller 308 can be configured to adjust the d-axis voltage component (V_{d}) based, at least in part, on the d-axis current error signal (e_{id}). For instance, the single-phase vector-like controller 308 can include a flux weakening current PI 360 (e.g., I_{d} Current PI 360). The flux weakening current PI 360 can be configured to determine the d-axis voltage component (V_{d}) based, at least in part, on the d-axis current error signal (e_{id}). Those of ordinary skill in the art will understand that the d-axis voltage component (V_{d}) can be adjusted in any suitable manner without deviating from the scope of the present disclosure.

Furthermore, referring to FIG. 5, the d-axis voltage component (V_{d}) can be combined with the phase of the rotor flux (θ) at 366, and the q-axis voltage component (V_{q}) can be combined with the phase of the rotor flux (θ) at 368. The voltage values determined at 366 and 368 can then be summed, at 370, with the DC voltage component (V₀) to calculate the total voltage (V) necessary to drive the motor. The total voltage (V) can then be sent to the inverter 310. The total voltage (V) can also be sent to the flux weakening controller 302. Accordingly, the total voltage (V) is given by:

$$V = {V}_{d} sin θ + {V}_{q} cos θ + {V}_{0}$$

FIG. 6 depicts a flow diagram of an example method 400 for implementing state limiting control for a motor of an appliance according to example embodiments of the present disclosure. The method 400 can be implemented to control a motor of a refrigerator appliance (e.g., as depicted in FIGS. 1-2). FIG. 6 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Additionally, method 400 is generally discussed with reference to the refrigerator appliance 10 described above with reference to FIGS. 1-2, and the motor assemblies 200, 300 described above with reference to FIGS. 4A-5. However, it should be understood that aspects of the present method 400 can find application with any suitable domestic appliance, motor assembly, motor, and/or controller.

As noted above, the method 400 provides a method for controlling a motor (e.g., motor 102) of an appliance (e.g., refrigerator appliance 10). For instance, a motor can be operated in order to drive a rotor of the motor. In some embodiments, the motor can be a single-phase motor such as, e.g., a single-phase linear motor. More particularly, a controller can be configured to implement a control scheme to operate the motor in order to drive a rotor of the motor. In such embodiments, the controller can be configured to implement a single-phase vector-like control scheme (e.g., as depicted in FIG. 5). In other embodiments, the motor can be a synchronous motor such as, e.g., a PMSM. More particularly, a controller can be configured to implement a control scheme to operate the motor in order to drive a rotor of the motor. In such embodiments, the controller can be configured to implement a field-oriented control (FOC) scheme (e.g., as depicted in FIGS. 4A-4B).

The method 400 may include (402) obtaining (e.g., via the limit controller 284, 384) a target signal for the motor. For example, continuing the example from above, drive assembly 100 may include motor 102 which is mechanically coupled to compressor 64 of sealed refrigeration system 60 of refrigerator appliance 10. The target signal may be a motor signal needed to drive compressor 64 to achieve the target sealed system demand and cooling needs for the refrigerator appliance 10. The target signal may be a target speed of the motor, a target q-axis current, and/or any other suitable target signal needed for achieving desired performance of the refrigerator appliance 10. The target signal may, for example, be received from a controller of the sealed system. As another example, the target signal may be determined from a signal (e.g., the target speed) received from the controller of the sealed system.

The method 400 may include (404) obtaining (e.g., via the limit controller 284, 384) one or more feedback measurements (Fₘ) of one or more components of the refrigerator appliance 10. Each of the feedback measurements (Fₘ) may be a dynamic variable indicating performance of the component of the refrigerator appliance 10. The feedback measurement(s) (Fₘ) may be measured by one or more sensors and/or determined (e.g., by one or more controllers) based on measurements received from the one or more sensors. The feedback measurement(s) (Fₘ) may include a power output, a temperature, a pressure, a voltage, a current, a magnetic flux and/or any other suitable feedback measurement.

The method 400 may include (406) comparing (e.g., via the limit controller 284, 384) each of the one or more feedback measurements (Fₘ) to a respective threshold. For instance, the limit controller 284, 384 can be configured to determine respective differences (e.g., via subtraction) between the feedback measurement(s) and the corresponding threshold(s). When at least one of the feedback measurement(s) exceeds the respective threshold(s) (i.e., when at least one of the differences has a negative value), the limit controller 284, 384 may determine that additional state limiting is required for operating the refrigerator appliance 10. As such, the method 400 can proceed to (408) in which an abatement mode is enabled. Alternatively, when each of the feedback measurement(s) is less than the respective threshold(s) (i.e., when each of the differences has a positive value), the limit controller 284, 384 may determine that additional state limiting is not required for operating the refrigerator appliance 10. As such, the method 400 can proceed to (410) in which the limit controller 284, 384 determines whether the abatement mode is enabled.

The limit controller 284, 384 can be configured to adjust the upper limit 282, 382 of the saturator 280, 380 when the abatement mode is enabled. For example, when at least one of the differences has a negative value, the limit controller 284, 384 can be configured to decrement the upper limit 282, 382, which balances state limiting of the motor and achieving demands for the refrigerator appliance 10. In some embodiments, the target DC current component (I*₀) may be decreased to zero (0) prior to decrementing the upper limit 282, 382. In addition, when each of the differences has a positive value, the limit controller 284, 384 can be configured to increment the upper limit 282, 382, which can prevent the feedback measurements (Fₘ) from alternating between exceeding and not exceeding the respective thresholds.

Each of the thresholds can be a predetermined value associated with the corresponding feedback measurements. For instance, the threshold(s) can be a value beyond which the component should not be operated during existing conditions. The threshold(s) may be determined in any suitable manner, may be fixed or variable, and may be supplied from any suitable source. For example, the threshold(s) may be fixed value(s) programmed into limit controller 284, 384. As another example, the threshold(s) may be determined as a function of the target signal. In this regard, for example, determining the threshold(s) for the feedback measurement(s) comprises determining the threshold(s) as a function of the target signal. The relationship between the threshold(s) and the target signal may be determined in any suitable manner. For example, the limit controller 284, 384 may be programmed with a lookup table that associates the threshold(s) with specific target signal. In addition, or alternatively, the relationship may be contained in one or more regression equations, mathematical models, or may be determined in any other suitable manner.

Referring still to FIG. 6, the method 400 may include (412) setting (e.g., via the limit controller 284, 384) the upper limit 282, 382 of the saturator 280, 380 to a maximum limit when the abatement mode is disabled. Further, the method 400 can include setting (e.g., via the limit controller 284, 384) an auxiliary limit to the target signal. Thereafter, the method 400 can proceed to (426).

The maximum limit can be a value beyond which the motor should not be operated during existing conditions. The maximum limit may be determined in any suitable manner, may be fixed or variable, and may be supplied from any suitable source. For example, the maximum limit may be a fixed value programmed into limit controller 284, 384.

Further, the method 400 may include (414) determining (e.g., via the limit controller 284, 384) one or more limit adjustments based on the one or more differences determined at (406). For instance, the limit controller 284, 384 can be configured to apply a respective gain (e.g., via multiplication and/or summation) to each of the differences to obtain the corresponding limit adjustments. Each gain may be a predetermined value. Each gain may be determined empirically (e.g., based on testing and/or simulation to determine a relationship between the corresponding feedback measurement (Fₘ) and the target signal). Thereafter, the method 400 can include (416) determining a minimum of the limit adjustment(s) according to the following:

$$A = min \{ \begin{matrix}{D}_{1} {G}_{1} \\ {D}_{2} {G}_{2} \\ … \\ {D}_{n} {G}_{n}\end{matrix}$$

where A is the minimum limit adjustment, D₁, D₂ and Dₙ are respective differences between feedback measurements (Fₘ) and corresponding thresholds, and G₁, G₂ and Gₙ are respective gains associated with the corresponding feedback measurements (Fₘ).

Furthermore, the method 400 may include (418) adjusting (e.g., via the limit controller 284, 384) the auxiliary limit based on the minimum limit adjustment A. More particularly, the limit controller 284, 384 can be configured to combine (e.g., via summation) the auxiliary limit and the minimum limit adjustment A. As noted above, the auxiliary limit is set to the target q-axis current component signal

$$( {I}_{q}^{*} )$$

prior to enablement of the abatement mode. As such, when the abatement mode is enabled, the auxiliary limit is initially adjusted by summing the target q-axis current component signal

$$( {I}_{q}^{*} )$$

and the minimum limit adjustment A. Subsequently, the auxiliary limit is adjusted by summing a previous auxiliary limit and the minimum limit adjustment A.

When at least one of the feedback measurements (Fₘ) exceeds the respective operating parameter, the corresponding differences Dₙ has a negative value. As such, the minimum limit adjustment A has a negative value. Hence, the minimum limit adjustment A is configured to decrement the auxiliary limit. When each of the feedback measurements (Fₘ) are below the respective operating parameters, each of the differences Dₙ has a positive value. As such, the minimum limit adjustment A has a positive value. Hence, the minimum limit adjustment A is configured to increment the auxiliary limit.

In addition, the method 400 can include (420) comparing (e.g., via the limit controller 284, 384) the updated auxiliary limit to the maximum limit. When the updated auxiliary limit is less than the maximum limit, the method proceeds to (422). Alternatively, when the updated auxiliary limit is greater than or equal to the maximum limit, the method proceeds to (424) in which the abatement mode is disabled. As such, the method 400 can proceed to (412).

The method 400 may include (422) setting (e.g., via the limit controller 284, 384) the upper limit 282, 382 to the updated auxiliary limit. Thereafter, the method 400 proceeds to (426).

The method 400 can include (426) determining an inverter output current to achieve the target signal. More particularly, the inverter output current can be determined based on the target q-axis current component signal

$$( {I}_{q}^{*} ) .$$

The target q-axis current component signal

$$( {I}_{q}^{*} )$$

is limited by the upper limit 282, 382 of the saturator 280, 380. Hence, the inverter output current is limited by the upper limit 282, 382. In this regard, a controller (e.g., the speed controller 216 or the stroke controller 304) may include a feedback control algorithm (e.g., such as a proportional-integral control) that determines a desired motor current that results in the actual motor speed being driven to the target speed.

The method 400 can include (428) supplying the motor with the inverter output current. In this regard, continuing the example from above, a controller (e.g., the current controller 218 or the single-phase vector-like controller 308) may receive the inverter output current and may generate the voltages necessary to provide that current to the motor 102. According to exemplary embodiments, the upper limit 282, 382 of the saturator 280, 380 may be adjusted to ensure feedback measurements (Fₘ) of one or more components of the refrigerator appliance 10 remain below respective thresholds. In this regard, for a given target signal, once the limit is reached, the controller (e.g., the speed controller 216 or the stroke controller 304) may no longer be able to accelerate the motor 102 and it will naturally steady out at some lower speed.

As explained above, aspects of the present disclosure are directed to a method for implementing state limiting or control in an inverter motor, e.g., that may be used to drive a compressor in refrigerator appliance 10 or any other suitable sealed system. Generally, a state monitor may be used to monitor and limit the output variable, and the monitored variable may be then reported to a mainboard or other controller. Further, to avoid design limits of components of the refrigerator appliance 10, one or more output variables controlled via the inverter control may be limited.

In order to overcome the aforementioned problems, aspects of the present disclosure may include motor state limiting in the inverter. The motor state limiting may include an inverter control limit that provides the ability to set a real upper limit based on maximum desired operating parameters.

For example, the present disclosure may incorporate state limiting control into a control scheme of a motor by enabling an abatement mode in response to one or more feedback measurements (Fₘ) of one or more components of the refrigerator appliance 10 exceeding respective thresholds. In the abatement mode, one or more limit adjustments are determined based on differences between the feedback measurement(s) (Fₘ) and the corresponding thresholds. The abatement mode then permits decrementing the upper limit based on a minimum adjustment so as to balance state limiting and desired performance of the motor. Furthermore, the abatement mode permits incrementing the upper limit when each of the differences between the feedback measurement(s) (Fₘ) and the corresponding thresholds has a positive value (i.e., each of the feedback measurement(s) (Fₘ) is below the respective thresholds). As such, the upper limit can be incremented back to a maximum limit prior to disablement of the abatement mode, which can prevent the feedback measurements (Fₘ) from alternating between exceeding and not exceeding the respective thresholds.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a motor of a domestic appliance, the method comprising:
obtaining a target signal for the motor;
obtaining a feedback measurement of a component of the domestic appliance;
in response to the feedback measurement exceeding a threshold, determining an upper limit based, at least in part, on a difference between the threshold and the feedback measurement;
limiting the target signal by the upper limit; and
controlling the motor based on the limited target signal.

2. The method of claim 1, wherein the target signal is one of a target speed or a target q-axis current.

3. The method of claim 1, wherein the feedback measurement comprises one of a power, a temperature, and a pressure.

4. The method of claim 1, wherein the upper limit is set to a maximum limit prior to the feedback measurement exceeding the threshold.

5. The method of claim 1, wherein, in response to the feedback measurement exceeding the threshold, determining the upper limit based, at least in part, on the difference between the threshold and the feedback measurement further comprises:
determining an adjustment by applying a gain to the difference, the adjustment configured to reduce the upper limit;
adjusting an auxiliary limit based on the adjustment, wherein the auxiliary limit is determined based, at least in part on, the target signal; and
setting the upper limit to the adjusted auxiliary limit.

6. The method of claim 1, further comprising, in response to the feedback measurement decreasing below the threshold, determining the upper limit based, at least in part, on a maximum limit and the difference between the threshold and the feedback measurement.

7. The method of claim 6, wherein, in response to the feedback measurement decreasing below the threshold, determining the upper limit based, at least in part, on the maximum limit and the difference between the threshold and the feedback measurement further comprises:
determining an adjustment by applying a gain to the difference, the adjustment configured to increase the upper limit;
adjusting an auxiliary limit based on the adjustment, wherein the auxiliary limit is determined based, at least in part on, the target signal; and
determining the upper limit based on the maximum limit and the adjusted auxiliary limit.

8. The method of claim 7, wherein determining the upper limit based on the maximum limit and the adjusted auxiliary limit further comprises:
setting the upper limit to the adjusted auxiliary limit when the adjusted auxiliary limit is less than the maximum limit; and
setting the upper limit to the maximum limit when the adjusted auxiliary limit is greater than or equal to the maximum limit.

9. The method of claim 1, further comprising controlling the motor by implementing field-oriented control (FOC).

10. The method of claim 9, wherein the motor is a synchronous motor.

11. The method of claim 1, further comprising controlling the motor by implementing single-phase vector-like control.

12. The method of claim 11, wherein the motor is a single-phase linear motor.

13. The method of claim 1, wherein the motor is operably coupled to a compressor of a sealed system.

14. The method of claim 13, wherein the sealed system is part of a refrigerator appliance or an air conditioner unit.

15. A motor assembly comprising:
a motor;
an inverter electrically coupled to an alternating current power supply and the motor; and
a controller in operative communication with the inverter, the controller configured to perform operations for controlling the motor, wherein the operations comprise:
obtaining a target signal for the motor;
obtaining a feedback measurement of a domestic appliance component;
in response to the feedback measurement exceeding a threshold, determining an upper limit based, at least in part, on a difference between the threshold and the feedback measurement;
limiting the target signal by the upper limit; and
controlling the motor based on the limited target signal.

16. The motor assembly of claim 15, wherein the upper limit is set to a maximum limit prior to the feedback measurement exceeding the threshold.

17. The motor assembly of claim 15, wherein, in response to the feedback measurement exceeding the threshold, determining the upper limit based, at least in part, on the difference between the threshold and the feedback measurement further comprises:
determining an adjustment by applying a gain to the difference, the adjustment configured to reduce the upper limit;
adjusting an auxiliary limit based on the adjustment, wherein the auxiliary limit is determined based, at least in part on, the target signal; and
setting the upper limit to the adjusted auxiliary limit.

18. The motor assembly of claim 15, wherein the operations further comprise, in response to the feedback measurement decreasing below the threshold, determining the upper limit based, at least in part, on a maximum limit and the difference between the threshold and the feedback measurement.

19. The motor assembly of claim 18, wherein, in response to the feedback measurement decreasing below the threshold, determining the upper limit based, at least in part, on the maximum limit and the difference between the threshold and the feedback measurement further comprises:
determining an adjustment by applying a gain to the difference, the adjustment configured to increase the upper limit;
adjusting an auxiliary limit based on the adjustment, wherein the auxiliary limit is determined based, at least in part on, the target signal; and
determining the upper limit based on the maximum limit and the adjusted auxiliary limit.

20. The motor assembly of claim 19, wherein determining the upper limit based on the maximum limit and the adjusted auxiliary limit further comprises:
setting the upper limit to the adjusted auxiliary limit when the adjusted auxiliary limit is less than the maximum limit; and
setting the upper limit to the maximum limit when the adjusted auxiliary limit is greater than or equal to the maximum limit.
